(19) United States
(12) Patent Application Publication
(10) Pub. No.: US 2024/0016151 A1
(43) Pub. Date: Jan. 18, 2024

(54) MICROCAPSULE AND LIQUID PESTICIDAL FORMULATION

(71) Applicant: SUMITOMO CHEMICAL COMPANY, LIMITED, Chuo-ku (JP)

(72) Inventor: Nobuhiro KISHI, Takarazuka-shi (JP)

(73) Assignee: SUMITOMO CHEMICAL COMPANY, LIMITED, Chuo-ku (JP)

(21) Appl. No.: 18/255,052

(22) PCT Filed: Nov. 30, 2021
(86) PCT No.: PCT/JP2021/043750

§ 371 Date: May 30, 2023

(30) Foreign Application Priority Data
Dec. 1, 2020 (JP) 2020-199852

(51) Int. Cl. A01N 43/54; A01N 25/34; A01N 43/84; A01N 25/10; A01P 13/00

(52) U.S. Cl. CPC A01N 43/54; A01N 25/34; A01N 43/84; A01N 25/10; A01P 13/00

(57) ABSTRACT

A microcapsule contains a core material included in a coating made of a resin, the core material including a liquid with a compound represented by the following formula (1) dissolved or suspended in an adjuvant, wherein a ratio between a weight of the core material and a weight of the coating (weight of the core material/weight of the coating) is 9 or more and 7999 or less:

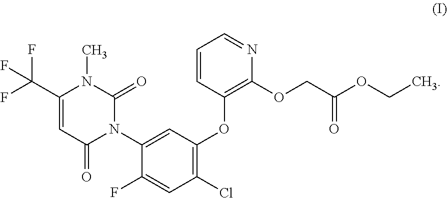 [SMILES: CCOC(=O)COc1ncccc1Oc1cc(-n2c(=O)cc(C(F)(F)F)n(C)c2=O)c(F)cc1Cl]

### TECHNICAL FIELD

The present invention relates to a microcapsule and a liquid pesticidal formulation containing the same.

### BACKGROUND ART

A compound represented by the following formula (1) (hereinafter, also called “compound (I)”), which is an active ingredient for herbicides, is known as a pesticidal active ingredient (see e.g., U.S. Pat. No. 6,537,948 (Patent Literature 1) and WO 2018/178039 (Patent Literature 2)).

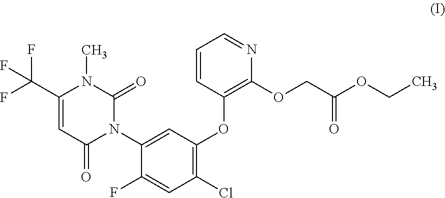 [SMILES: CCOC(=O)COc1ncccc1Oc1cc(-n2c(=O)cc(C(F)(F)F)n(C)c2=O)c(F)cc1Cl]

### CITATION LIST

### Patent Literature

PTL 1: U.S. Pat. No. 6,537,948

PTL 2 :WO 2018/178039

### SUMMARY OF INVENTION

### Technical Problem

In general, adjuvants are known as materials that are added in order to potentiate the action of pesticides or modify the physical properties of mixtures for sprayings (spray liquids). It has been newly found that when a formulation in which a suspension concentrate containing a compound (I) is supplemented with an adjuvant is prepared, the compound (I) may aggregate.

An object of the present invention is to provide a microcapsule that can prevent the aggregation of the compound (I) in a formulation supplemented with the compound (I) and an adjuvant, and a liquid pesticidal formulation containing the same.

### Solution to Problem

The present invention provides the following microcapsule and liquid composition.
[1] A microcapsule comprising a core material included in a coating made of a resin, the core material comprising a liquid with a compound represented by the following formula (1) dissolved or suspended in an adjuvant, wherein
a ratio between a weight of the core material and a weight of the coating (weight of the core material/weight of the coating) is 9 or more and 7999 or less:

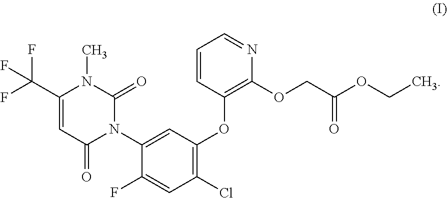 [SMILES: CCOC(=O)COc1ncccc1Oc1cc(-n2c(=O)cc(C(F)(F)F)n(C)c2=O)c(F)cc1Cl]

[2] The microcapsule according to [1], wherein the ratio between the weight of the core material and the weight of the coating (weight of the core material/weight of the coating) is 80 or more and 4000 or less.
[3] The microcapsule according to [1] or [2], wherein the adjuvant comprises one or more ingredients selected from the group consisting of mineral oils, vegetable oils, ester-based solvents and amide-based solvents.
[4] The microcapsule according to any of [1] to [3], wherein one or more pesticidal active compounds different from the compound represented by the formula (I) are dissolved or suspended in the adjuvant.
[5] The microcapsule according to [4], wherein the pesticidal active compound comprises flumioxazin.
[6] The microcapsule according to any of [1] to [5], wherein the resin comprises a resin prepared by polymerizing a monomer ingredient comprising an isocyanate group in the structure.
[7] The microcapsule according to any of [1] to [5], wherein the resin comprises one or more resins selected from the group consisting of polyurea and polyurethane.
[8] The microcapsule according to any of [1] to [7], wherein a volume median diameter of the microcapsule is 1 μm or larger and 100 μm or smaller.
[9] A liquid composition comprising a microcapsule according to any of [1] to [8] dispersed in water.

### Advantageous Effects of Invention

According to the present invention, it is made possible to provide a microcapsule that can prevent the aggregation of the compound (I) in a formulation and a liquid pesticidal formulation containing the same.

### DESCRIPTION OF EMBODIMENTS

### Microcapsule

A microcapsule according to the present invention (hereinafter, also called “present MC”) contains a core material included in a coating made of a resin (hereinafter, also called “present coating”), the core material including a liquid with a compound (I) dissolved or suspended in an adjuvant (hereinafter, also called “present liquid”). In the present MC, a ratio between a weight of the core material and a weight of the present coating (weight of the core material/weight of the coating) is 9 or more and 7999 or less.

The present coating constitutes the shell of the present MC. The resin constituting the present coating can employ a resin that is generally used as a coating for microcapsule pesticidal formulations. Examples of the resin include resins prepared by polymerizing a monomer ingredient including an isocyanate group in the structure (hereinafter, also called “isocyanate monomer”), such as polyurethane and polyurea, melamine resin, polyamide resin, polyester resin, polysulfonate resin, polysulfonamide resin, epoxy resin, alkyd resin, phenol resin, silicone resin, and combinations of these resins. The resin is preferably a resin prepared by polymerizing an isocyanate monomer, more preferably one or more selected from the group consisting of polyurea and polyurethane, further preferably aromatic polyurea and/or aromatic polyurethane having an aromatic ring such as a benzene ring in the structure of the resin.

The present liquid is contained in a core material. The present liquid is a liquid with the compound (I) dissolved or suspended in an adjuvant.

In general, adjuvants are known as materials that are added in order to potentiate the action of pesticides or modify the physical properties of mixtures for sprayings (spray liquids). The adjuvant is a composition containing an ingredient that exerts an adjuvant effect (hereinafter, also called “adjuvant ingredient”). It is preferable that one or more selected from the group consisting of mineral oils, vegetable oils, ester-based solvents and amide-based solvents be contained as the adjuvant ingredient. The present liquid contains one, two, or more adjuvants.

The mineral oil is an oil of mineral matter such as petroleum and contains a mixture of hydrocarbons. Examples of the hydrocarbon include paraffinic hydrocarbons, naphthenic hydrocarbons, aromatic hydrocarbons, other unsaturated hydrocarbons and combinations thereof.

The vegetable oil is an oil extracted from a seed. Examples of the seed include the seeds of corn, cotton, peanut, rape, sunflower, canola and soybean. The vegetable oil may be a vegetable oil modified by methylation or the like.

Examples of the ester-based solvent include ethyl acetate, butyl acetate, amyl acetate, isoamyl acetate, isobornyl acetate, hexyl acetate, heptyl acetate, octyl acetate, ethyl lactate, propyl lactate, ethylene carbonate, propylene carbonate, butylene carbonate, diethyl carbonate, dibutyl carbonate, isopropyl myristate, methyl octanoate, methyl oleate, methyl laurate, dibutyl adipate, tri-w-butyl citrate, di-w-butyl phthalate, glycerol acetate, glycol acetate, glycerin monoacetate, glycerin diacetate, glycerin triacetate, diethylene glycol abietate, dipropylene glycol dibenzoate, dipropylene glycol monomethyl ester, and γ-butyrolactone.

Examples of the amide-based solvent include N-octyl-caprolactam, N-dodecyl-caprolactam, N,N-dimethylformamide, N,N-dimethylacetamide, N,N-dimethyldecanamide, N,N-dimethyloctanamide, alkylpyrrolidones such as N-methylpyrrolidone, N-octyl-pyrrolidone, and N-dodecyl-pyrrolidone, α-lactam (3-membered ring), β-lactam (4-membered ring), γ-lactam (5-membered ring), and δ-lactam.

The content of the adjuvant in the present liquid is, for example, 5 wt % or more and may be 30 wt % or more, may be 50 wt % or more, may be 60 wt % or more, may be 70 wt % or more, may be 80 wt % or more, and may be 85 wt % or more, and is, for example, 99.9 wt % or less and may be 99 wt % or less, may be 95 wt % or less, and may be 90 wt % or less, in terms of the adjuvant ingredient. When the present liquid or the present MC contains two or more adjuvants, the content of the adjuvant refers to the total content thereof.

The compound (I) is a known compound and has an excellent herbicidal efficacy. The compound (I) can be synthesized by, for example, a method described in Patent Literature 1. The compound (I) is a solid at a temperature of 25° C. and is present in a state dissolved or suspended in the adjuvant in the present MC.

The content of the compound (I) in the present liquid is, for example, 0.10 wt % or more and may be 0.50 wt % or more, may be 1 wt % or more, may be 5 wt % or more, may be 10 wt % or more, and may be 20 wt % or more, and may be, for example, 60 wt % or less, may be 40 wt % or less, and may be 30 wt % or less.

The weight ratio between the content of the compound (I) and the content of the adjuvant ingredient (weight of the compound (I)/weight of the adjuvant ingredient) may be 0.002 or more, may be 0.01 or more, may be 0.1 or more, may be 0.25 or more, and may be 0.5 or more, and may be 2.0 or less, may be 1.5 or less, and may be 1.0 or less. One or more pesticidal active compounds (hereinafter, also called “additional pesticidal active compound”) different from the compound (I) may be dissolved or suspended in the adjuvant contained in the present liquid. The additional pesticidal active compound is not particularly limited as long as it is a pesticidal active compound other than the compound (I). A preferable additional pesticidal active compound is a pesticidal active compound that is poorly water-insoluble and is a solid at a temperature of 25° C. The poorly water-insoluble pesticidal active compound herein refers to a pesticidal active compound having a solubility of 1 g or less per L of water at a temperature of 25° C.

A more preferable additional pesticidal active compound is a herbicidal active compound that is poorly water-insoluble and is a solid at a temperature of 25° C. Examples of such a herbicidal active compound include flumioxazin, mesotrione, pyroxasulfone, simetryn, daimuron, propanil, mefenacet, fentrazamide, etobenzanid, swep, oxaziclomefone, pyrazolate, prodiamine, cafenstrole, pentoxazone, clomeprop, pyriftalid, benzobicyclon, bromobutide, imazosulfuron, and propyrisulfuron. A preferable herbicidal active compound is flumioxazin.

Flumioxazin is a known compound and can be synthesized by, for example, a method described in Japanese Patent Laying-Open Nos. 61-76486 and 5-97848.

The content of the additional pesticidal active compound in the present liquid is, for example, 0.10 wt % or more and may be 0.50 wt % or more, may be 1 wt % or more, may be 5 wt % or more, may be 10 wt % or more, and may be 20 wt % or more, and may be, for example, 60 wt % or less, may be 40 wt % or less, and may be 30 wt % or less. When the additional pesticidal active compound is two or more pesticidal active compounds, the content of the additional pesticidal active compound refers to the total content thereof

When the present liquid contains the compound (I) and the additional pesticidal active compound, the weight ratio between the content of the compound (I) and the content of the additional pesticidal active compound (weight of the compound (I)/weight of the additional pesticidal active compound) in the present liquid is, for example, 0.1 or more and may be 0.2 or more, may be 0.5 or more, and may be 1 or more, and is, for example, 10 or less and may be 5 or less and may be 3 or less.

The core material constitutes the core of the present MC and contains the present liquid. The core material may contain other ingredients other than the present liquid.

In the present MC, the ratio between the weight of the core material and the weight of the present coating (weight of the core material/weight of the coating) is 9 or more and may be 80 or more, may be 100 or more, may be 200 or more, and may be 300 or more. The ratio (weight of the core material/weight of the coating) is 7999 or less and may be 7000 or less, may be 6000 or less, may be 5000 or less, may be 4000 or less, may be 3000 or less, may be 2000 or less, and may be 1000 or less.

The weight of the core material is the total weight of the ingredients constituting the core material and is specifically the total weight of the present liquid (containing the compound (I) and the adjuvant) and optional other ingredients. The weight of the coating is the weight of an oil-soluble monomer that forms the resin.

The ratio (weight of the core material/weight of the coating) falls within the range, whereby the aggregation of the compound (I) or the present MC in the present liquid composition can be prevented. If the weight of the coating of the microcapsule is relatively small so that the ratio (weight of the core material/weight of the coating) is larger than the range, the liquid composition, when stored under repeated conditions of a low-temperature condition and a high-temperature condition, easily causes the aggregation of the compound (I) or the crystal deposition of the compound (I) and increases the risk of blocking spray nozzles. If the weight of the coating of the microcapsule is relatively large so that the ratio (weight of the core material/weight of the coating) is smaller than the range, the liquid composition, when stored under high-temperature conditions, easily causes the aggregation of microcapsules containing the compound (I) and increases the risk of blocking spray nozzles.

The volume median diameter of the present MC is usually 1 μm or larger and may be 3 μm or larger, may be 5 μm or larger, may be 10 μm or larger, and may be 20 μm or larger, and is usually 100 μm or smaller and may be 80 μm or smaller, may be 50 μm or smaller, and may be 30 μm or smaller.

The volume median diameter of the present MC is measured using a laser diffraction particle size distribution measurement apparatus. The volume median diameter, also called median diameter, is a typical characteristic value that represents a particle size distribution in a collection of particles. The volume median diameter refers to the particle diameter of particles that reaches 50% based on the total volume of the collection of particles (cumulative 50% volume particle diameter) determined by determining the particle diameters of individual particles in a collection of particles, and accumulating the volumes of the particles in the ascending order of the particle diameters, with the total volume of the collection of particles being taken as 100%. Mastersizer 3000 (manufactured by Spectris Co., Ltd.) can be used (measurement conditions are as follows: measurement object: spherical, refractive index: 1.52, absorptance: 0.1, density: 1 (g/cm³), dispersion medium: water (refractive index: 1.33)) as a commercially available laser diffraction particle size distribution measurement apparatus.

When the compound (I) and/or the additional pesticidal active compound is suspended in the present liquid, it is preferable that the volume median diameters of the compound (I) and the additional pesticidal active compound be smaller than the volume median diameter of the present MC.

(Composition Containing Microcapsule)

The present MC can be dispersed in a solid or liquid diluent carrier and used. Examples of the solid diluent carrier include mineral matter such as kaolin clay, attapulgite clay, bentonite, montmorillonite, Japanese acid clay, pyrophyllite, talc, diatomaceous earth, and calcite, natural organic matter such as corn cob powders and walnut shell powders, synthetic matter such as urea, salts such as calcium carbonate and ammonium sulfate, and synthetic inorganic matter such as synthetic hydrous silicon oxide. Examples of the liquid diluent carrier include water.

(Liquid Composition)

A liquid composition according to the present invention (hereinafter, also called “composition of the present invention”) is a composition containing water, which is a liquid, as the diluent carrier described above, and includes the present MC dispersed in the water.

Examples of the water include ion-exchange water, tap water and groundwater. The content of the water in the composition of the present invention is usually 30 wt % or more and may be 40 wt % or more and may be 50 wt % or more, and is usually 80 wt % or less and may be 70 wt % or less and may be 60 wt % or less.

The content of the compound (I) in the composition of the present invention is usually 0.01 wt % or more, preferably 0.1 wt % or more, 0.5 wt % or more, 1 wt % or more, 5 wt % or more, or 10 wt % or more, and is usually 30 wt % or less, preferably 20 wt % or less.

The composition of the present invention may contain the additional pesticidal active compound described above in the water.

The composition of the present invention may further contain a herbicidal active compound other than the compound (I) and the additional pesticidal active compound described above in the water. Examples of the herbicidal active compound include glyphosate potassium salt, glyphosate dimethylamine salt, glyphosate monoethanolamine salt, glufosinate ammonium salt, glufosinate P ammonium salt, glyphosate isopropylammonium salt, 2,4-D choline salt, 2,4-D dimethylamine salt, dicamba diglycolamine salt, dicamba BAPMA salt, dicamba tetrabutylamine salt, dicamba tetrabutylphosphonium salt, flumiclorac-pentyl, clethodim, lactofen, S metolachlor, metribuzin, flufenacet, nicosulfuron, rimsulfuron, acetochlor, isoxaflutole, chlorimuron-ethyl, thifensulfuron-methyl, cloransulam-methyl, and imazethapyr ammonium salt.

The composition of the present invention may optionally contain other formulation aids. Examples of other formulation aids include surfactants, thickeners, antifoaming agents, antifreezing agents, antiseptics, and colorants.

Examples of the surfactant include anionic surfactants, nonionic surfactants, cationic surfactants, amphoteric surfactants and mixtures thereof. A preferable surfactant is a nonionic surfactant.

Preferable examples of the nonionic surfactant include alkylphenols (e.g., octylphenol, nonylphenol, and octylcresol), allylphenols, acylphenols, isotridecyl alcohol, oleyl alcohol, cetyl alcohol, starch, starch derivatives, sucrose, alkyl polyglucosides, sorbitan, ethoxylated sorbitan, cellulose derivatives, gum arabic, polyvinyl alcohol, polyethylene glycol, fatty acid alkanolamides (e.g., lauric acid diethanolamide), alkoxylated propylene oxide fatty acid glucamides, polyoxyethylene oleic acid amide, polyoxyethylene stearic acid amide, polyvinylpyrrolidone, polyoxyethylene oleylamine, alkoxylated amines (e.g., polyoxyethylene oleylamine), α,α′-[(9-octadecenylimino)di-2,1-ethanediyl]bis(co-hydroxy)poly(oxyethylene), fatty acid esters of polyols, monoglyceride, phospholipids, sucrose stearic acid diester, sorbitan fatty acid esters (e.g., sorbitan oleic acid monoester), glucose ester, cellulose ester, vinyl acetate copolymers, polymethacrylic acid, copolymers of methacrylic acid and methacrylic acid ester, aliphatic alcohol ethoxylates (e.g., tridecyl alcohol ethoxylate, isooctyl alcohol ethoxylate, lauryl alcohol ethoxylate, hexadecyl alcohol ethoxylate, and stearyl alcohol ethoxylate), alkylphenol ethoxylates (e.g., nonylphenol ethoxylate, tributylphenol ethoxylate, and octylphenol ethoxylate), tristyryl phenol ethoxylate, arylalkylphenol ethoxylates (e.g., monobenzyl biphenol alcohol ethoxylate), aliphatic alcohol propoxylates, alkylphenol propoxylates, arylalkylphenol propoxylates, block polymers of polyethylene oxide and polypropylene oxide, block polymers of alkanol, polyethylene oxide, and polypropylene oxide, polyoxyethylene fatty acid esters (e.g., polyoxyethylene castor oil ester, polyoxyethylene stearic acid ester, and polyoxyethylene beef tallow fatty acid ester), polyoxyethylene sorbitan fatty acid esters (e.g., polyoxyethylene sorbitan monooleic acid ester, polyoxyethylene sorbitan trioleic acid ester, polyoxyethylene sorbitan monolauric acid ester, and polyoxyethylene sorbitan stearic acid ester), polyoxyethylene fatty acid amine esters, polyoxyethylene rosin esters, polyoxypropylene fatty acid esters (e.g., polyoxypropylene castor oil ester and polyoxypropylene fatty acid amine ester), and undecafluorohexanoic acid.

A preferable anionic surfactant is a sulfonate, a sulfuric acid ester salt, a phosphoric acid ester salt, a carboxylate and a mixture thereof. Examples of the sulfonate include alkylsulfonates (e.g., dodecylsulfonate), alpha olefinsulfonates (e.g., alkylbenzenesulfonates (e.g., decylbenzenesulfonate, dodecylbenzenesulfonate, and tridecylbenzenesulfonate)), diphenylsulfonate, naphthalenesulfonate, alkylnaphthal enesulfonates (e.g., dibutylnaphthalenesulfonate), 2,2′-dinaphthylmethane-6,6′-disulfonate, diisopropylnaphthalenesulfonate, triisopropylnaphthalenesulfonate, dialkylsulfosuccinates (e.g., sodium di(2-ethylhexyl)sulfosuccinate), N-methyl-N-acyltaurine salts (e.g., methyl oleoyl taurate), and others, for example, ligninsulfonate, alkylphenolsulfonates and derivatives thereof, naphthalenesulfonate-formaldehyde condensates and derivatives thereof, and benzimidazole sulfonic acid derivatives. Examples of the sulfuric acid ester salt include alkyl sulfates (e.g., n-hexyl sulfate), n-heptyl sulfate, lauryl sulfate, lauryl sulfuric acid diethanol salt, octadecyl sulfate, polyoxyethylene alkyl ether sulfates (e.g., laureth-3-sulfate), and polyoxypropylene alkyl ether sulfates. Examples of the phosphoric acid ester salt include alkyl phosphates such as lauryl phosphate, and derivatives thereof, polyoxyethylene alkyl ether phosphates and derivatives thereof, polyoxyethylene alkyl phenyl ether phosphates and derivatives thereof, and polyoxypropylene alkyl ether phosphates and derivatives thereof. Examples of the carboxylate include fatty acid salts such as octanoate, decanoate, laurate, myristate, palmitate, stearate, behenate, and oleate, and derivatives thereof, ether carboxylates such as laureth-3-carboxylate, and derivatives thereof, N-acylsarcosine salts such as N-lauroylsarcosine salt, and derivatives thereof, N-acylglutamates such as N-lauroylglutamate, and derivatives thereof, polycarboxylates such as polyacrylates, polyvinyl acetates, and comb-shaped polymers of polyacid salts, and derivatives thereof.

Preferable examples of the cationic surfactant include alkylamine salts such as monomethylamine salt, dimethylamine salt, and trimethylamine salt, fatty acid amide amine salts such as stearamide propyldimethylamine and behenamide propyldimethylamine, polyamine salts such as polyvinylamine and polyethyleneimine, and quaternary ammonium salts such as lauryltrimethylammonium salt, cetyltrimethylammonium salt, stearylmethylammonium salts, and ethylammonium benzylbis(2-chloroethyl)bromide.

The content of the surfactant in the composition of the present invention is usually 0.1 wt % or more and may be 0.5 wt % or more, may be 0.75 wt % or more, may be 1 wt % or more, may be 1.5 wt % or more, may be 2.0 wt % or more, may be 2.5 wt % or more, may be 3 wt % or more, may be 4 wt % or more, and may be 5 wt % or more, and is usually 15 wt % or less and may be 10 wt % or less and may be 7.5 wt % or less. When the composition of the present invention contains two or more surfactants, the content of the surfactant refers to the total content thereof.

Examples of the thickener include natural polysaccharides such as xanthan gum, rhamsan gum, locust bean gum, carrageenan, and welan gum, synthetic polymers such as sodium polyacrylate, semisynthetic polysaccharides such as carboxymethylcellulose, fine powders of mineral matter such as aluminum magnesium silicate, smectite, bentonite, hectorite, and fumed silica, and alumina sol. The content of the thickener in the composition of the present invention is usually 0.05 wt % or more and may be 0.07 wt % or more, and is usually 10 wt % or less and may be 5 wt % or less and may be 3 wt % or less.

Examples of the antifoaming agent include silicone-based antifoaming agents. The content of the antifoaming agent in the composition of the present invention is usually 0.01 wt % or more and may be 0.05 wt % or more, and is usually 2 wt % or less and may be 1 wt % or less and may be 0.5 wt % or less.

Examples of the antifreezing agent include ethylene glycol, propylene glycol, urea, and glycerin. The content of the antifreezing agent in the composition of the present invention is usually 1 wt % or more and may be 2 wt % or more, and is usually 10 wt % or less and may be 8 wt % or less.

Examples of the antiseptic include isothiazolinone-based antiseptics. The content of the antiseptic in the composition of the present invention is usually 0.05 wt % or more and may be 0.1 wt % or more, and is usually 1 wt % or less and may be 0.5 wt % or less.

The composition of the present invention can be used in crop lands such as dry fields, orchard fields, pastures, lawn fields, and forestry fields; and non-crop lands such as levee slopes, riverbeds, shoulders and slopes of the roads, railroads, parks and green spaces, playgrounds, automobile parks, airports, and industrial plant sites such as factories and storage facilities as well as idle fields and urban deserts, thereby controlling weeds.

Users prepare a suspension by usually mixing the composition of the present invention with water, and apply it from a knapsack sprayer, a spray tank, a spray plane, or an irrigation system. Although the amount of spray differs depending on climate conditions, the timing of treatment, soil conditions, target crops, target weeds, etc., usually 10 L or more and 2000 L or less, preferably 50 L or more and 400 L or less, of a spray liquid per hectare is applied. Also, the suspension is prepared by mixing the pesticidal composition with water in usually from 2 to 10000 times, preferably from 10 to 8000 times, more preferably from 15 to 6000 times the volume of the suspension concentrate.

(Methods for Producing Microcapsule and Composition)

The present MC can be produced by a usual microencapsulation method, for example, an interfacial polymerization method or an in-situ method. It is preferable that the present MC be produced by an interfacial polymerization method because the film thickness of the coating in the resulting microcapsule is easily controlled. In the following, the case of producing the present MC by the interfacial polymerization method will be described as an example.

First, the compound (I), the adjuvant, and optional other ingredients are mixed, and further, the oil-soluble monomer among the raw materials of the resin constituting the present coating is added thereto and mixed to obtain a homogenous or suspended oil phase. The oil-soluble monomer herein usually refers to a monomer having a solubility of less than 50 g per 1 L of water at a temperature of 25° C. When the resin constituting the present coating is polyurea and/or polyurethane, polyvalent isocyanate is usually used as the oil-soluble monomer of the resin.

Next, the obtained oil phase is added to an aqueous phase containing an optional surfactant, and mixed and dispersed (dispersion step) to obtain a dispersion. To the dispersion, an optional water-soluble monomer among the raw materials of the resin constituting the present coating is added, and coating formation reaction is performed at the interface (coating formation step) to obtain an aqueous dispersion in which the present MC is dispersed. The water-soluble monomer herein is a monomer that is added to the aqueous phase, and usually refers to a monomer having a solubility of 50 g or more per 1 L of water at a temperature of 25° C. When the resin constituting the present coating is polyurethane, a polyhydric alcohol is used as the water-soluble monomer among the raw materials of the resin. When the resin constituting the present coating is polyurea, polyvalent amine is usually used as the water-soluble monomer among the raw materials of the resin. The formation temperature of the present coating in the coating formation step usually ranges from 40 to 85° C., and the time required for the coating formation is usually from 1 to 90 hours. When the temperature in the dispersion step is sufficiently lower than the temperature of the coating formation step, the water-soluble monomer among the raw materials of the resin may be added in the dispersion step.

The obtained present MC can be isolated by a method such as the filtration of the aqueous dispersion in which the present MC is dispersed. The isolated present MC can be dispersed in an optional diluent carrier to prepare a composition containing the present MC and the composition of the present invention. To the aqueous dispersion in which the present MC is dispersed, obtained by the production method described above, an optional formulation aid such as a thickener, an antifoaming agent, an antifreezing agent, or an antiseptic may be added to prepare the composition of the present invention.

Examples of the polyvalent isocyanate serving as a raw material of the resin constituting the present coating include: aliphatic polyvalent isocyanates such as hexamethylene diisocyanate, adducts of hexamethylene diisocyanate and trimethylolpropane, biuret condensates of three molecules of hexamethylene diisocyanate, isocyanurate condensates of hexamethylene diisocyanate, isocyanurate condensates of isophorone diisocyanate, 4,4′-methylenebis(cyclohexyl isocyanate), and trimethylhexamethylene diisocyanate; and aromatic polyvalent isocyanates such as trimethylolpropane adducts of tolylene diisocyanate, isocyanurate condensates of tolylene diisocyanate, diphenylmethane diisocyanate, and polymethylene polyphenyl polyisocyanate.

Examples of the polyhydric alcohol serving as a raw material of the resin constituting the present coating include ethylene glycol, propylene glycol, and 1,4-butanediol. Examples of the polyvalent amine include ethylenediamine, hexamethylenediamine, diethylenetriamine, and triethylenetetramine.

The volume median diameter of the present MC described above can be adjusted by adjusting (i) the type and concentration of the surfactant to be dissolved in the aqueous phase, (ii) the ratio between the aqueous phase and the oil phase, and/or (iii) a dispersion method and stirring intensity in dispersing the oil phase in the aqueous phase, in the dispersion step of the method for producing the present MC. For example, the type and the concentration of the surfactant to be dissolved in the aqueous phase are set. The oil phase is mixed with the aqueous phase at a volume ratio of 0.3 to 2 of the oil phase to 1 of the aqueous phase, and the oil phase is dispersed in the aqueous phase under appropriate operating conditions of dispersion equipment used. The volume median diameter of oil droplets in the obtained dispersion is measured using a laser diffraction particle size distribution measurement apparatus. When a larger volume median diameter of oil droplets in the dispersion thus obtained is desired, the volume median diameter can be increased by a method such as the lowering of the surfactant concentration, the decrease of stirring intensity in dispersing the oil phase in the aqueous phase, the decrease of the volume ratio of the oil phase to the aqueous phase, and/or the change of the surfactant. When a smaller volume median diameter of oil droplets in the obtained dispersion is desired, the volume median diameter can be decreased by a method such as the elevation of the surfactant concentration, the increase of stirring intensity in dispersing the oil phase in the aqueous phase, the increase of the volume ratio of the oil phase to the aqueous phase, and/or the change of the surfactant.

Examples of the dispersing machine that can be used in the dispersion step include propeller stirrers, high-speed rotational stirrers, homogenizers, and Homomic Line Flow (manufactured by Tokushu Kika Kogyo Co., Ltd.).

The composition of the present invention prevents the crystal deposition of the compound (I), the crystal growth of the compound (I), the aggregation the present MC, and the segregation of the composition (formulation) itself when stored in a low-temperature and/or high-temperature environment, and exhibits high herbicidal activity when applied.

### EXAMPLES

In the following, the present invention will be described in further detail with reference to Examples and Comparative Examples, etc. The scope of the present invention is not limited to these Examples.

The products and prescriptions used in the preparation of microcapsules and liquid compositions are shown in Table 1 and in the following.

TABLE 1

| | | | Compar- | Compar- | Compar- | Compar- | Produc- | Produc- | Produc- | Produc- | Produc- |
|---|---|---|---|---|---|---|---|---|---|---|---|
| | | | ative | ative | ative | ative | tion | tion | tion | tion | tion |
| | | Compound or | Production | Production | Production | Production | Exam- | Exam- | Exam- | Exam- | Exam- |
| | | product | Example 1 | Example 2 | Example 3 | Example 4 | ple 1 | ple 2 | ple 3 | ple 4 | ple 5 |
| Raw | Pesticidal | Compound (I) | 0.750 | 10.000 | 10.000 | 10.000 | 10.000 | 0.750 | 10.000 | 10.000 | 10.000 |
| material | active | Flumioxazin | — | — | — | — | — | — | — | — | — |
| of core | compound | | | | | | | | | | |
| material | Adjuvant | Solvesso 200ND | 20.000 | 20.000 | 20.000 | 20.000 | 20.000 | 20.000 | 20.000 | 20.000 | 20.000 |
| Raw | Oil-soluble | Desmodur L75 | — | — | — | 0.005 | 0.010 | 0.100 | 0.100 | 0.100 | — |
| material | monomer* | (C)** | | | | | | | | | |
| of coating | | Papi 27 | — | — | — | — | — | — | — | — | — |
| | | Sumidur 44S | — | — | — | — | — | — | — | — | 0.100 |
| | Water-soluble | Hexamethyl- | — | — | — | — | — | — | — | 0.018 | 0.046 |
| | monomer | enediamine | | | | | | | | | |

| Surfactant | Soprophor FLK | 1.000 | 5.000 | — | — | — | — | — | — | — |
|---|---|---|---|---|---|---|---|---|---|---|
| | Selvol 523 | 1.500 | 1.500 | 1.500 | 1.500 | 1.500 | 1.500 | 1.500 | 1.500 | 1.500 |
| Thickener | Kelzan S plus | 0.150 | 0.150 | 0.150 | 0.150 | 0.150 | 0.150 | 0.150 | 0.150 | 0.150 |
| | Veegum R | 0.300 | 0.300 | 0.300 | 0.300 | 0.300 | 0.300 | 0.300 | 0.300 | 0.300 |
| Antiseptic | Proxel GXL | 0.200 | 0.200 | 0.200 | 0.200 | 0.200 | 0.200 | 0.200 | 0.200 | 0.200 |
| Antifreezing agent | Propylene glycol | 5.000 | 5.000 | 5.000 | 5.000 | 5.000 | 5.000 | 5.000 | 5.000 | 5.000 |
| Antifoaming agent | Xiameter AFE- | 0.200 | 0.200 | 0.200 | 0.200 | 0.200 | 0.200 | 0.200 | 0.200 | 0.200 |
| | 1530 | | | | | | | | | |
| Diluent | Deionized water | 70.900 | 57.650 | 62.650 | 62.645 | 62.640 | 71.800 | 62.550 | 62.532 | 62.504 |

| | | | | | | | | | |
|---|---|---|---|---|---|---|---|---|---|
| Total(w/w %) | 100.000 | 100.000 | 100.000 | 100.000 | 100.000 | 100.000 | 100.000 | 100.000 | 100.000 |

| | | | Produc- | Produc- | Produc- | Compar- | Compar- | Compar- |
|---|---|---|---|---|---|---|---|---|
| | | | tion | tion | tion | ative | ative | ative |
| | | Compound or | Exam- | Exam- | Exam- | Production | Production | Production |
| | | product | ple 6 | ple 7 | ple 8 | Example 5 | Example 6 | Example 7 |
| Raw | Pesticidal | Compound (I) | 10.000 | 0.750 | 10.000 | 10.000 | 10.000 | 10.000 |
| material | active | Flumioxazin | — | 3.250 | — | — | — | — |
| of core | compound | | | | | | | |
| material | Adjuvant | Solvesso 200ND | 20.000 | 20.000 | 20.000 | 20.000 | 20.000 | 20.000 |
| Raw | Oil-soluble | Desmodur L75 | — | — | 0.500 | 5.000 | 5.000 | — |
| material | monomer* | (C)** | | | | | | |
| of coating | | Papi 27 | 0.100 | 0.100 | — | — | — | — |
| | | Sumidur 44S | — | — | — | — | — | 5.000 |
| | Water-soluble | Hexamethyl- | — | — | — | — | 0.920 | 2.300 |
| | monomer | enediamine | | | | | | |

| Surfactant | Soprophor FLK | — | — | — | — | — | — |
|---|---|---|---|---|---|---|---|
| | Selvol 523 | 1.500 | 1.500 | 1.500 | 1.500 | 1.500 | 1.500 |
| Thickener | Kelzan S plus | 0.150 | 0.150 | 0.150 | 0.150 | 0.150 | 0.150 |
| | Veegum R | 0.300 | 0.300 | 0.300 | 0.300 | 0.300 | 0.300 |
| Antiseptic | Proxel GXL | 0.200 | 0.200 | 0.200 | 0.200 | 0.200 | 0.200 |
| Antifreezing agent | Propylene glycol | 5.000 | 5.000 | 5.000 | 5.000 | 5.000 | 5.000 |
| Antifoaming agent | Xiameter AFE- | 0.200 | 0.200 | 0.200 | 0.200 | 0.200 | 0.200 |
| | 1530 | | | | | | |
| Diluent | Deionized water | 62.550 | 68.550 | 62.150 | 57.650 | 56.730 | 55.350 |

| | | | | | | |
|---|---|---|---|---|---|---|
| Total(w/w %) | 100.000 | 100.000 | 100.000 | 100.000 | 100.000 | 100.000 |

*The amount of the oil-soluble monomer added was calculated as the weight of the coating.
**Containing 25% ethyl acetate, the content was calculated in terms of the raw material of the core material.

(Adjuvant)
Solvesso 200ND: Containing C10-C13 alkyl naphthalene as its main aromatic hydrocarbon, manufactured by ExxonMobil Chemical

(Raw Materials of Inclusion and Microcapsule)
Desmodur L75 (C): Trimethylolpropane adduct of tolylene diisocyanate (75 wt %: oil-soluble monomer), ethyl acetate (25 wt %), manufactured by Covestro
Papi 27 (oil-soluble monomer): Diphenylmethane diisocyanate, isomer and polymeric diphenylmethane diisocyanate, manufactured by Dow
Sumidur 44S (oil-soluble monomer): Diphenylmethane-4,4′-diisocyanate, manufactured by Covestro
Hexamethylenediamine (water-soluble monomer): manufactured by FUJIFILM Wako Pure Chemical Corp.

(Surfactant)
Soprophor FLK: Mixture of polyoxyethylene tristyryl phenyl ether phosphoric acid ester salt and propylene glycol, manufactured by Solvay
Selvol 523: Polyvinyl alcohol, manufactured by Sekisui Chemical Co., Ltd.

(Thickener)
Kelzan S Plus: Xanthan gum, manufactured by CP Kelco
Veegum R: Aluminum magnesium silicate, manufactured by R.T. Vanderbilt Company. Inc

(Anti Foaming Agent)
XIAMETER AFE-1530: Silicone-based mixture, manufactured by Dow Corning Toray Co., Ltd.

(Antifreezing Agent)
Propylene glycol: manufactured by Adeka

(Antiseptic)
Proxel GXL: 1,2-Benzoisothiazolin-3-one, manufactured by Lonza

### Comparative Production Example 1

To 22.75 parts by weight of ion-exchange water, 0.20 parts by weight of XTAMETER AFE-1530, 0.30 parts by weight of Veegum R, 1.00 part by weight of Soprophor FLK, and 0.75 parts by weight of the compound (I) were added, then stirred and mixed, and wet-milled using a bead mill (product name: DYNO-MILL, manufactured by Shinmaru Enterprises Corp.) to obtain 25.00 parts by weight of a suspension (1).

To a mixed solution of 1.50 parts by weight of Selvol 523 and 28.50 parts by weight of ion-exchange water, 20.00 parts by weight of Solvesso 200ND were added, and stirred and emulsified at 7000 rpm for 3 minutes in 200 mL Polycup using Polytron homogenizer (manufactured by KINEMATICA) and a shaft (PT-DA3020/2) to obtain 50.00 parts by weight of an emulsion (1).

0.15 parts by weight of Kelzan S Plus, 5.00 parts by weight of Propylene glycol, 0.20 parts by weight of Proxel GXL and 14.65 parts by weight of ion-exchange water were mixed to obtain 20.00 parts by weight of a thickener-containing liquid (1).

25.00 parts by weight of suspension (1), 50.00 parts by weight of emulsion (1), 20.00 parts by weight of thickener-containing liquid (1), and 5.00 parts by weight of ion-exchange water were mixed to obtain a liquid composition (hereinafter, called “comparative liquid composition 1”).

### Comparative Production Example 2

To 9.50 parts by weight of ion-exchange water, 0.20 parts by weight of XIAMETER AFE-1530, 0.30 parts by weight of Veegum R, 5.00 parts by weight of Soprophor FLK, and 10.00 parts by weight of the compound (I) were added, then stirred and mixed, and wet-milled using a bead mill (product name: DYNO-MILL, manufactured by Shinmaru Enterprises Corp.) to obtain 25.00 parts by weight of a suspension (2).

25.00 parts by weight of suspension (2), 50.00 parts by weight of emulsion (1) obtained by the same preparation method as in Comparative Production Example 1, 20.00 parts by weight of thickener-containing liquid (1) obtained by the same preparation method as in Comparative Production Example 1, and 5.00 parts by weight of ion-exchange water were mixed to obtain a liquid composition (hereinafter, called “comparative liquid composition 2”).

### Comparative Production Example 3

10.00 parts by weight of the compound (I) and 20.00 parts by weight of Solvesso 200ND were mixed and wet-milled to obtain 30.00 parts by weight of a suspension (3). 35.90 parts by weight of ion-exchange water, 0.10 parts by weight of XIAMETER AFE-1530, and 1.50 parts by weight of Selvol 523 were mixed to obtain 37.50 parts by weight of an aqueous phase (1). To 37.50 parts by weight of aqueous phase (1) thus prepared, 30.00 parts by weight of suspension (3) were added, and stirred and emulsified at 7000 rpm for 3 minutes in 200 mL Polycup using Polytron homogenizer (manufactured by KINEMATICA) and a shaft (PT-DA3020/2) to obtain 67.50 parts by weight of an emulsion (2). Emulsion (2) contained an inclusion with the compound (I) included in the adjuvant.

0.30 parts by weight of Veegum R, 0.15 parts by weight of Kelzan S Plus, 0.20 parts by weight of Proxel GXL, 5.00 parts by weight of Propylene glycol, and 14.35 parts by weight of ion-exchange water were mixed to obtain 20.00 parts by weight of a thickener-containing liquid (2).

67.50 parts by weight of emulsion (2) containing the inclusion, 20.00 parts by weight of thickener-containing liquid (2), 0.10 parts by weight of XIAMETER AFE-1530, and 12.40 parts by weight of ion-exchange water were mixed to obtain a liquid composition (hereinafter, also called “comparative liquid composition 3”). The volume median diameter of the inclusion in comparative liquid composition 3 was measured using Mastersizer 3000 (manufactured by Spectris Co., Ltd.) under measurement conditions of measurement object: spherical, refractive index: 1.52, absorptance: 0.1, density: 1 (g/cm³), and dispersion medium: water (refractive index: 1.33), and was consequently 7.0 μm.

### Comparative Production Example 4

10.00 parts by weight of the compound (I) and 20.00 parts by weight of Solvesso 200ND were mixed and wet-milled, and 0.005 parts by weight of Desmodur L75 (C) were added thereto to obtain 30.005 parts by weight of a suspension (4). To 37.50 parts by weight of aqueous phase (1) obtained by the same preparation method as in Comparative Production Example 3, 30.005 parts by weight of suspension (4) were added, and stirred and emulsified at 7000 rpm for 3 minutes in 200 mL Polycup using Polytron homogenizer (manufactured by KINEMATICA) and a shaft (PT-DA3020/2) to obtain 67.505 parts by weight of an emulsion (3). Emulsion (3) thus obtained was heated to 60° C. and stirred at the same temperature thereas for 8 hours to obtain 67.505 parts by weight of a microcapsule dispersion (1).

67.505 parts by weight of microcapsule dispersion (1), 20.00 parts by weight of thickener-containing liquid (2) obtained by the same preparation method as in Comparative Production Example 3, 0.10 parts by weight of XIAMETER AFE-1530, and 12.395 parts by weight of ion-exchange water were mixed to obtain a liquid composition (hereinafter, also called “comparative liquid composition 4”). The volume median diameter of the microcapsule in comparative liquid composition 4 was measured by the measurement method performed in Comparative Production Example 3, and was consequently 6.9 μm.

### Production Example 1

10.00 parts by weight of the compound (I) and 20.00 parts by weight of Solvesso 200ND were mixed and wet-milled, and 0.01 parts by weight of Desmodur L75 (C) were added thereto to obtain 30.01 parts by weight of a suspension (5). To 37.50 parts by weight of aqueous phase (1) obtained by the same preparation method as in Comparative Production Example 3, 30.01 parts by weight of suspension (5) were added, and stirred and emulsified at 7000 rpm for 3 minutes in 200 mL Polycup using Polytron homogenizer (manufactured by KINEMATICA) and a shaft (PT-DA3020/2) to obtain 67.51 parts by weight of an emulsion (4). Emulsion (4) thus obtained was heated to 60° C. and stirred at the same temperature thereas for 8 hours to obtain 67.51 parts by weight of a microcapsule dispersion (2).

67.51 parts by weight of microcapsule dispersion (2), 20.00 parts by weight of thickener-containing liquid (2) obtained by the same preparation method as in Comparative Production Example 3, 0.10 parts by weight of XIAMETER AFE-1530, and 12.39 parts by weight of ion-exchange water were mixed to obtain a liquid composition (hereinafter, also called “present liquid composition 1”). The volume median diameter of the microcapsule in present liquid composition 1 was measured by the measurement method performed in Comparative Production Example 3, and was consequently 6.6

### Production Example 2

0.75 parts by weight of the compound (I) and 20.00 parts by weight of Solvesso 200ND were mixed and wet-milled, and 0.10 parts by weight of Desmodur L75 (C) were added thereto to obtain 20.85 parts by weight of an oil phase. To 37.50 parts by weight of aqueous phase (1) obtained by the same preparation method as in Comparative Production Example 3, 20.85 parts by weight of the oil phase were added, and stirred and emulsified at 7000 rpm for 3 minutes in 200 mL Polycup using Polytron homogenizer (manufactured by KINEMATICA) and a shaft (PT-DA3020/2) to obtain 58.35 parts by weight of an emulsion (5). Emulsion (5) thus obtained was heated to 60° C. and stirred at the same temperature thereas for 8 hours to obtain 58.35 parts by weight of a microcapsule dispersion (3).

58.35 parts by weight of microcapsule dispersion (3), 20.00 parts by weight of thickener-containing liquid (2) obtained by the same preparation method as in Comparative Production Example 3, 0.10 parts by weight of XIAMETER AFE-1530, and 21.55 parts by weight of ion-exchange water were mixed to obtain a liquid composition (hereinafter, also called “present liquid composition 2”). The volume median diameter of the microcapsule in present liquid composition 2 was measured by the measurement method performed in Comparative Production Example 3, and was consequently 9.2

### Production Example 3

10.00 parts by weight of the compound (I) and 20.00 parts by weight of Solvesso 200ND were mixed and wet-milled, and 0.10 parts by weight of Desmodur L75 (C) were added thereto to obtain 30.10 parts by weight of a suspension (6). To 37.50 parts by weight of aqueous phase (1) obtained by the same preparation method as in Comparative Production Example 3, 30.10 parts by weight of suspension (6) were added, and stirred and emulsified at 7000 rpm for 3 minutes in 200 mL Polycup using Polytron homogenizer (manufactured by KINEMATICA) and a shaft (PT-DA3020/2) to obtain 67.60 parts by weight of an emulsion (6). Emulsion (6) thus obtained was heated to 60° C. and stirred at the same temperature thereas for 8 hours to obtain 67.60 parts by weight of a microcapsule dispersion (4).

67.60 parts by weight of microcapsule dispersion (4), 20.00 parts by weight of thickener-containing liquid (2) obtained by the same preparation method as in Comparative Production Example 3, 0.10 parts by weight of XIAMETER AFE-1530, and 12.30 parts by weight of ion-exchange water were mixed to obtain a liquid composition (hereinafter, also called “present liquid composition 3”). The volume median diameter of the microcapsule in present liquid composition 3 was measured by the measurement method performed in Comparative Production Example 3, and was consequently 7.3 μm.

### Production Example 4

To 37.50 parts by weight of aqueous phase (1) obtained by the same preparation method as in Comparative Production Example 3, 30.10 parts by weight of suspension (6) obtained by the same preparation method as in Production Example 3 were added, and stirred and emulsified at 7000 rpm for 3 minutes in 200 mL Polycup using Polytron homogenizer (manufactured by KINEMATICA) and a shaft (PT-DA3020/2) to obtain 67.60 parts by weight of an emulsion (7). 67.60 parts by weight of emulsion (7) thus obtained and 0.018 parts by weight of hexamethylenediamine were mixed, heated to and stirred at the same temperature thereas for 8 hours to obtain 67.618 parts by weight of a microcapsule dispersion (5).

67.618 parts by weight of microcapsule dispersion (5), 20.00 parts by weight of thickener-containing liquid (2) obtained by the same preparation method as in Comparative Production Example 3, 0.10 parts by weight of XIAMETER AFE-1530, and 12.282 parts by weight of ion-exchange water were mixed to obtain a liquid composition (hereinafter, also called “present liquid composition 4”). The volume median diameter of the microcapsule in present liquid composition 4 was measured by the measurement method performed in Comparative Production Example 3, and was consequently 7.6 μm.

### Production Example 5

10.00 parts by weight of the compound (I) and 20.00 parts by weight of Solvesso 200ND were mixed and wet-milled, and 0.10 parts by weight of Sumidur 44S were added thereto to obtain 30.10 parts by weight of a suspension (7). To 37.50 parts by weight of aqueous phase (1) obtained by the same preparation method as in Comparative Production Example 3, 30.10 parts by weight of suspension (7) were added, and stirred and emulsified at 7000 rpm for 3 minutes in 200 mL Polycup using Polytron homogenizer (manufactured by KINEMATICA) and a shaft (PT-DA3020/2) to obtain 67.60 parts by weight of an emulsion (8). 67.60 parts by weight of emulsion (8) thus obtained and 0.046 parts by weight of hexamethylenediamine were mixed, heated to 60° C., and stirred at the same temperature thereas for 8 hours to obtain 67.646 parts by weight of a microcapsule dispersion (6).

67.646 parts by weight of microcapsule dispersion (6), 20.00 parts by weight of thickener-containing liquid (2) obtained by the same preparation method as in Comparative Production Example 3, 0.10 parts by weight of XIAMETER AFE-1530, and 12.254 parts by weight of ion-exchange water were mixed to obtain a liquid composition (hereinafter, also called “present liquid composition 5”). The volume median diameter of the microcapsule in present liquid composition 5 was measured by the measurement method performed in Comparative Production Example 3, and was consequently 7.2 μm.

### Production Example 6

10.00 parts by weight of the compound (I) and 20.00 parts by weight of Solvesso 200ND were mixed and wet-milled, and 0.10 parts by weight of Papi 27 were added thereto to obtain 30.10 parts by weight of a suspension (8). To 37.50 parts by weight of aqueous phase (1) obtained by the same preparation method as in Comparative Production Example 3, 30.10 parts by weight of suspension (8) were added, and stirred and emulsified at 7000 rpm for 3 minutes in 200 mL Polycup using Polytron homogenizer (manufactured by KINEMATICA) and a shaft (PT-DA3020/2) to obtain 67.60 parts by weight of an emulsion (9). Emulsion (9) thus obtained was heated to 60° C. and stirred at the same temperature thereas for 8 hours to obtain 67.60 parts by weight of a microcapsule dispersion (7).

67.60 parts by weight of microcapsule dispersion (7), 20.00 parts by weight of thickener-containing liquid (2) obtained by the same preparation method as in Comparative Production Example 3, 0.10 parts by weight of XIAMETER AFE-1530, and 12.30 parts by weight of ion-exchange water were mixed to obtain a liquid composition (hereinafter, also called “present liquid composition 6”). The volume median diameter of the microcapsule in present liquid composition 6 was measured by the measurement method performed in Comparative Production Example 3, and was consequently 7.9

### Production Example 7

0.75 parts by weight of the compound (I), 3.25 parts by weight of flumioxazin as an additional pesticidal active compound, and 20.00 parts by weight of Solvesso 200ND were mixed and wet-milled, and 0.10 parts by weight of Papi 27 were added thereto to obtain 24.10 parts by weight of a suspension (9). To 37.50 parts by weight of aqueous phase (1) obtained by the same preparation method as in Comparative Production Example 3, 24.10 parts by weight of suspension (9) were added, and stirred and emulsified at 7000 rpm for 3 minutes in 200 mL Polycup using Polytron homogenizer (manufactured by KINEMATICA) and a shaft (PT-DA3020/2) to obtain 61.60 parts by weight of an emulsion (10). Emulsion (10) thus obtained was heated to and stirred at the same temperature thereas for 8 hours to obtain 61.60 parts by weight of a microcapsule dispersion (8).

61.60 parts by weight of microcapsule dispersion (8), 20.00 parts by weight of thickener-containing liquid (2) obtained by the same preparation method as in Comparative Production Example 3, 0.10 parts by weight of XIAMETER AFE-1530, and 18.30 parts by weight of ion-exchange water were mixed to obtain a liquid composition (hereinafter, also called “present liquid composition 7”). The volume median diameter of the microcapsule in present liquid composition 7 was measured by the measurement method performed in Comparative Production Example 3, and was consequently 8.0 μm.

### Production Example 8

parts by weight of the compound (1) and 20.00 parts by weight of Solvesso 200ND were mixed and wet-milled, and 0.50 parts by weight of Desmodur L75 (C) were added thereto to obtain 30.50 parts by weight of a suspension (10). To 37.50 parts by weight of aqueous phase (1) obtained by the same preparation method as in Comparative Production Example 3, 30.50 parts by weight of suspension (10) were added, and stirred and emulsified at 7000 rpm for 3 minutes in 200 mL Polycup using Polytron homogenizer (manufactured by KINEMATICA) and a shaft (PT-DA3020/2) to obtain 68.00 parts by weight of an emulsion (11). Emulsion (11) thus obtained was heated to 60° C. and stirred at the same temperature thereas for 8 hours to obtain 68.00 parts by weight of a microcapsule dispersion (9).

68.00 parts by weight of microcapsule dispersion (9), 20.00 parts by weight of thickener-containing liquid (2) obtained by the same preparation method as in Comparative Production Example 3, 0.10 parts by weight of XIAMETER AFE-1530, and 11.90 parts by weight of ion-exchange water were mixed to obtain a liquid composition (hereinafter, also called “present liquid composition 8”). The volume median diameter of the microcapsule in present liquid composition 8 was measured by the measurement method performed in Comparative Production Example 3, and was consequently 7.7 μm.

### Comparative Production Example 5

10.00 parts by weight of the compound (I) and 20.00 parts by weight of Solvesso 200ND were mixed and wet-milled, and 5.00 parts by weight of Desmodur L75 (C) were added thereto to obtain 35.00 parts by weight of a suspension (11). To 37.50 parts by weight of aqueous phase (1) obtained by the same preparation method as in Comparative Production Example 3, 35.00 parts by weight of suspension (11) were added, and stirred and emulsified at 7000 rpm for 3 minutes in 200 mL Polycup using Polytron homogenizer (manufactured by KINEMATICA) and a shaft (PT-DA3020/2) to obtain 72.50 parts by weight of an emulsion (12). Emulsion (12) thus obtained was heated to 60° C. and stirred at the same temperature thereas for 8 hours to obtain 72.50 parts by weight of a microcapsule dispersion (10).

72.50 parts by weight of microcapsule dispersion (10), 20.00 parts by weight of thickener-containing liquid (2) obtained by the same preparation method as in Comparative Production Example 3, 0.10 parts by weight of XIAMETER AFE-1530, and 7.40 parts by weight of ion-exchange water were mixed to obtain a liquid composition (hereinafter, also called “comparative liquid composition 5”). The volume median diameter of the microcapsule in comparative liquid composition 5 was measured by the measurement method performed in Comparative Production Example 3, and was consequently 7.1 μm.

### Comparative Production Example 6

To 37.50 parts by weight of aqueous phase (1) obtained by the same preparation method as in Comparative Production Example 3, 35.00 parts by weight of suspension (11) obtained by the same preparation method as in Comparative Production Example 5 were added, and stirred and emulsified at 7000 rpm for 3 minutes in 200 mL Polycup using Polytron homogenizer (manufactured by KINEMATICA) and a shaft (PT-DA3020/2) to obtain 72.50 parts by weight of an emulsion (13). 72.50 parts by weight of emulsion (13) thus obtained and 0.92 parts by weight of hexamethylenediamine were mixed, heated to 60° C., and stirred at the same temperature thereas for 8 hours to obtain 73.42 parts by weight of a microcapsule dispersion (11).

73.42 parts by weight of microcapsule dispersion (11), 20.00 parts by weight of thickener-containing liquid (2) obtained by the same preparation method as in Comparative Production Example 3, 0.10 parts by weight of XIAMETER AFE-1530, and 6.48 parts by weight of ion-exchange water were mixed to obtain a liquid composition (hereinafter, also called “comparative liquid composition 6”). The volume median diameter of the microcapsule in comparative liquid composition 6 was measured by the measurement method performed in Comparative Production Example 3, and was consequently 7.9 μm.

### Comparative Production Example 7

10.00 parts by weight of the compound (I) and 20.00 parts by weight of Solvesso 200ND were mixed and wet-milled, and 5.00 parts by weight of Sumidur 44S were added thereto to obtain 35.00 parts by weight of a suspension (12). To 37.50 parts by weight of aqueous phase (1) obtained by the same preparation method as in Comparative Production Example 3, 35.00 parts by weight of suspension (12) were added, and stirred and emulsified at 7000 rpm for 3 minutes in 200 mL Polycup using Polytron homogenizer (manufactured by KINEMATICA) and a shaft (PT-DA3020/2) to obtain 72.50 parts by weight of an emulsion (14). 72.50 parts by weight of emulsion (12) thus obtained and 2.3 parts by weight of hexamethylenediamine were mixed, heated to 60° C., and stirred at the same temperature thereas for 8 hours to obtain 74.80 parts by weight of a microcapsule dispersion (12).

74.80 parts by weight of microcapsule dispersion (12), 20.00 parts by weight of thickener-containing liquid (2) obtained by the same preparation method as in Comparative Production Example 3, 0.10 parts by weight of XIAMETER AFE-1530, and 5.10 parts by weight of ion-exchange water were mixed to obtain a liquid composition (hereinafter, also called “comparative liquid composition 7”). The volume median diameter of the microcapsule in comparative liquid composition 7 was measured by the measurement method performed in Comparative Production Example 3, and was consequently 5.6 μm.

[Calculation of Ratio Between Weight of Core Material and Weight of Coating (Weight of Core Material/Weight of Coating) in Microcapsule]

The weight of the core material was calculated as the total weight of the compound (I), the additional pesticidal active ingredient, the adjuvant, and ethyl acetate contained in the oil-soluble monomer (Desmodur L75).

The weight of the coating was calculated as the weight of the oil-soluble monomer.

On the basis of the calculated weight of the core material and weight of the coating, the ratio (weight of the core material/weight of the coating) was calculated. The results are shown in Table 2.

### Test Example 1

The presence or absence of occurrence of aggregates was confirmed as to each of the liquid compositions prepared in Comparative Production Examples and Production Examples. The results are shown in the column “Initial” in Table 2.

Each of the liquid compositions prepared in Comparative Production Examples and Production Examples was placed in a glass vessel and stored at a temperature of 60° C. The presence or absence of occurrence of aggregates was confirmed up to the second weeks from the start of the storage (stability when actually stored for a given period in a storage environment with a relatively high temperature simulating summer, etc. was evaluated in an acceleration system). The results are shown in the column “High temperature” in Table 2.

Each of the liquid compositions prepared in Comparative Production Examples and Production Examples was placed in a glass vessel, and a cycle of storage at a temperature of −10° C. for 24 hours and storage at a temperature of 40° C. for 24 hours was repeated. The presence or absence of occurrence of aggregates was confirmed up to the second weeks from the start of the storage (stability when actually stored for a given period in a storage environment with repeated freezing and thawing simulating winter, etc. was evaluated in an acceleration system). The results are shown in the column “Cycle” in Table 2.

In all the cases, the presence or absence of occurrence of aggregates was confirmed under a microscope (350×) or visually.

TABLE 2

| | | | | Occurrence of aggregate | | |
|---|---|---|---|---|---|---|
| | | Microcapsule | | | High | |
| | Liquid composition | dispersion | Ratio*² | Initial | temperature | Cycle |
| Comparative | Comparative liquid | — | — | Present | — | — |
| Production Example 1 | composition 1 | | | | | |
| Comparative | Comparative liquid | — | — | Present | — | — |
| Production Example 2 | composition 2 | | | | | |
| Comparative | Comparative liquid | — | — | Absent | Absent | Present |
| Production Example 3 | composition 3 | | | | | |
| Comparative | Comparative liquid | (1) | 8000 | Absent | Absent | Present |
| Production Example 4 | composition 4 | | | | | |
| Production Example 1 | Present liquid | (2) | 4000 | Absent | Absent | Absent |
| | composition 1 | | | | | |
| Production Example 2 | Present liquid | (3) | 277 | Absent | Absent | Absent |
| | composition 2 | | | | | |
| Production Example 3 | Present liquid | (4) | 400 | Absent | Absent | Absent |
| | composition 3 | | | | | |
| Production Example 4 | Present liquid | (5) | 400 | Absent | Absent | Absent |
| | composition 4 | | | | | |
| Production Example 5 | Present liquid | (6) | 300 | Absent | Absent | Absent |
| | composition 5 | | | | | |
| Production Example 6 | Present liquid | (7) | 300 | Absent | Absent | Absent |
| | composition 6 | | | | | |
| Production Example 7 | Present liquid | (8) | 240 | Absent | Absent | Absent |
| | composition 7 | | | | | |
| Production Example 8 | Present liquid | (9) | 80 | Absent | Absent | Absent |
| | composition 8 | | | | | |
| Comparative | Comparative liquid | (10) | 8 | Absent | Present | Absent |
| Production Example 5 | composition 5 | | | | | |
| Comparative | Comparative liquid | (11) | 8 | Absent | Present | Absent |
| Production Example 6 | composition 6 | | | | | |
| Comparative | Comparative liquid | (12) | 6 | Absent | Present | Present |
| Production Example 7 | composition 7 | | | | | |

*²Weight of core material/weight of coating in microcapsule

### Test Example 2

The weeds (Palmer amaranth (Amaranthus palmeri), narrow leaf amaranthus (Amaranthus graecizanus), common ragweed (Ambrosia artemisiaefolia), giant ragweed (Ambrosia trifida), marestail (Conyza canadensis), common lambsquarters (Chenopodium album), kochia (Kochia scoparia), common barnyardgrass (Echinochloa crus-galli) and giant foxtail (Setaria faberi)) are seeded to a plastic pot containing soil. On the same day, the surface of soil is treated with a mixture of any one of present liquid compositions 1 to 8, Agri-Dex (mixture of heavy paraffin oil, polyhydric alcohol fatty acid ester, and a polyethoxylate derivative, manufactured by Helena Chemical, specific gravity: 0.88), Induce (polyoxyalkylene alkyl ether, polyoxyalkylene fatty acid ester, alkylaryl alkoxylate, or alkylaryl polyoxyalkylene glycol, manufactured by Helena Chemical, specific gravity: 0.99), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27), XtendiMAX Herbicide with VaporGrip Technology (dicamba diglycolamine salt, manufactured by Bayer, specific gravity: 1.2) and water. Their respective amounts in the treatment are 20 g/ha (in terms of the compound (I)) of the present liquid composition, 1232 g/ha of Agri-Dex, 346.5 g/ha of Induce, 742 g/ha of Intact, 1858 g/ha of Vapex, a VaporGrip Xtra Agent, and 1931 g/ha of XtendiMAX Herbicide with VaporGrip Technology, and the amount of the spray liquid is 140 L/ha. Then, they are cultivated in a greenhouse. Seven days later, soybean is seeded. Fourteen days later, a weed control effect and a crop injury to the soybean are investigated. In the case of using any of the formulations, an excellent weed control effect is confirmed.

### Test Example 3

The weeds (Palmer amaranth (Amaranthus palmeri), narrow leaf amaranthus (Amaranthus graecizanus), common ragweed (Ambrosia artemisiaefblia), giant ragweed (Ambrosia trifida), marestail (Conyza canadensis), common lambsquarters (Chenopodium album), kochia (Kochia scoparia), common barnyardgrass (Echinochloa crus-galli) and giant foxtail (Setaria laberi)) are seeded to a plastic pot containing soil. On the same day, the surface of soil is treated with a mixture of any one of present liquid compositions 1 to 8, Agri-Dex (mixture of heavy paraffin oil, polyhydric alcohol fatty acid ester, and a polyethoxylate derivative, manufactured by Helena Chemical, specific gravity: 0.88), Silwet L77 (organic silicone, manufactured by Helena Chemical, specific gravity: 1.007), Intact (mixture of polyethylene glycol, choline chloride, and guar gum, manufactured by Precision Laboratories, specific gravity: 1.06), Vapex, a VaporGrip Xtra Agent (mixture of potassium hydroxide and acetic acid, manufactured by Kalo, specific gravity: 1.27), XtendiMAX Herbicide with VaporGrip Technology (dicamba diglycolamine salt, manufactured by Bayer, specific gravity: 1.2) and water. Their respective amounts in the treatment are 20 g/ha (in terms of the compound (I)) of the present liquid composition, 1232 g/ha of Agri-Dex, 3.5245 g/ha of Silwet L77, 742 g/ha of Intact, 389 g/ha of Vapex, a VaporGrip Xtra Agent, and 1931 g/ha of XtendiMAX Herbicide with VaporGrip Technology, and the amount of the spray liquid is 140 L/ha. Then, they are cultivated in a greenhouse. Seven days later, soybean is seeded. Fourteen days later, a weed control effect and a crop injury to the soybean are investigated. In the case of using any of the formulations, an excellent weed control effect is confirmed.

1. A microcapsule comprising a core material included in a coating made of a resin, the core material comprising a liquid with a compound represented by the following formula (I) dissolved or suspended in an adjuvant, wherein
a ratio between a weight of the core material and a weight of the coating (weight of the core material/weight of the coating) is 9 or more and 7999 or less:

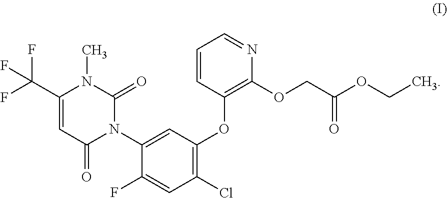 [SMILES: CCOC(=O)COc1ncccc1Oc1cc(-n2c(=O)cc(C(F)(F)F)n(C)c2=O)c(F)cc1Cl]

2. The microcapsule according to claim 1, wherein the ratio between the weight of the core material and the weight of the coating (weight of the core material/weight of the coating) is 80 or more and 4000 or less.

3. The microcapsule according to claim 1, wherein the adjuvant comprises one or more ingredients selected from the group consisting of mineral oils, vegetable oils, ester-based solvents and amide-based solvents.

4. The microcapsule according to claim 1, wherein one or more pesticidal active compounds different from the compound represented by the formula (I) are dissolved or suspended in the adjuvant.

5. The microcapsule according to claim 4, wherein the pesticidal active compound comprises flumioxazin.

6. The microcapsule according to claim 1, wherein the resin comprises a resin prepared by polymerizing a monomer ingredient comprising an isocyanate group in the structure.

7. The microcapsule according to claim 1, wherein the resin comprises one or more resins selected from the group consisting of polyurea and polyurethane.

8. The microcapsule according to claim 1, wherein a volume median diameter of the microcapsule is 1 μm or larger and 100 μm or smaller.

9. A liquid composition comprising a microcapsule according to claim 1 dispersed in water.
